(19) United States
(12) Patent Application Publication
(10) Pub. No.: US 2026/0119961 A1
(43) Pub. Date: Apr. 30, 2026

(54) System and method for securing data in software applications and networks utilizing quantum computing

(71) Applicant: Bank of America Corporation, Charlotte, NC (US)

(72) Inventors: Manu Jacob Kurian, Dallas, TX (US); Michael Robert Young, Davidson, NC (US)

(21) Appl. No.: 18/786,736

(22) Filed: Jul. 29, 2024

(51) Int. Cl. G06N 20/00; G06N 10/60

(52) U.S. Cl. CPC G06N 20/00; G06N 10/60

(57) ABSTRACT

A system includes a memory configured to store instances of a software application executable on a computing device and a set of public data. The system includes a processor operably coupled to the memory and configured to detect an interaction to initiate execution of user interactions with the set of public data. The processor is further configured to execute one or more generative machine-learning models trained to extract, based on the set of public data, a set of data to be inputted into a trusted network for obfuscating from public view sets of private data, and identify, based on the extracted set of data, the sets of private data. The processor is further configured to input the extracted set of data into the trusted network, and initiate execution of user interactions with the sets of private data based on the extracted set of data as inputted into the trusted network.

### TECHNICAL FIELD

The present disclosure relates generally to quantum computing, and, more specifically, to a system and method for securing data in software applications and networks utilizing quantum computing.

### BACKGROUND

Certain cloud-computing based environments may include data stored across any number of databases and associated with any number of entities. For example, the data may include various user data or service data that may be stored to databases associated with respective entities, and that user data or service data may be accessed by any number of centralized or decentralized servers for servicing applications associated with various users. However, such cloud-computing based environments may be sometimes subjected to various threats and cyberattacks.

### SUMMARY

The system and methods implemented by the system as disclosed in the present disclosure provide technical solutions to the technical problems discussed above by providing systems and methods for securing and obfuscating data in software applications and networks utilizing quantum computing. The disclosed system and methods provide several practical applications and technical advantages. Specifically, the present embodiments improve the efficiency, accuracy, speed, and security of data integration, migration, and processing, as well as the one or more processors and memory on which the data integration, migration, and processing may be executed and stored by accelerating data integration, migration, and processing utilizing quantum computing. The present embodiments provide a combined classical computing and quantum computing system that utilizes one or more generative machine-learning models (e.g., one or more classical machine-learning (CML) models, one or more quantum machine-learning (QML) models, or some combination thereof) trained to 1) extract, based on public data, a set of data to be inputted into a trusted network for obfuscating from public view private data that may be included within the public data, and 2) identify, based on the extracted data, the private data as inputted into the trusted network.

In particular embodiments, the combined classical computing and quantum computing system may then input the extracted data into a trusted network for obfuscating from public view the private data as the private data is further accessed, analyzed, migrated, and/or processed and stored. In this way, the present embodiments may leverage the voluminous data that may be exchanged between user computing devices and the combined classical computing and quantum computing system to extract from a large set of public data a set of data including both public and private data to be inputted into a trusted network concealed from public view. The present embodiments may then further identify, within the data inputted into the trusted network, the private data for further analysis, integration, processing, and/or migration all while being concealed from public view.

Specifically, by the data inputted into the trusted network including both public and private data, potential attackers, eavesdroppers, or other adversarial users that may have view of all or some of the large set of public data may be impeded from deciphering the private data from amongst the larger sets of public data. That is, the data inputted into the trusted network including both public and private data allows the public data to serve as decoy data to deceive and isolate potential attackers, eavesdroppers, or other adversarial users.

The present embodiments are directed to systems and methods for securing and obfuscating data in software applications and networks utilizing quantum computing. In particular embodiments, a system includes a memory configured to store a plurality of instances of a software application executable on a computing device and a set of public data associated with at least one instance of the software application. In particular embodiments, the system may further include one or more processors operably coupled to the memory and configured to detect an interaction to initiate an execution of one or more user interactions with the set of public data associated with the at least one instance of the software application. In particular embodiments, the one or more processors may be further configured to detect the interaction to initiate the execution of the one or more user interactions with the set of public data based on a computing device.

In particular embodiments, the one or more processors may be further configured to execute one or more generative machine-learning models trained to 1) extract, based at least in part on the set of public data, a set of data to be inputted into a trusted network for obfuscating from public view one or more sets of private data included within the set of public data, and 2) identify, based at least in part on the extracted set of data, the one or more sets of private data as inputted into the trusted network. For example, in one embodiment, the one or more generative machine-learning models may include one or more classical machine-learning (CML) models, one or more quantum machine-learning (QML) models, or a combination thereof. In particular embodiments, the extracted set of data may include the one or more sets of private data and a subset of public data included within the set of public data.

In particular embodiments, the one or more processors may be further configured to input the extracted set of data into the trusted network for obfuscating from public view the one or more sets of private data. In particular embodiments, the one or more processors may be further configured to store the extracted set of data as one or more quantum bits (QuBits) of data to a quantum memory of the system or as one or more bits of data to a relational database of the system. In particular embodiments, in response to the extracted set of data being inputted into the trusted network, the one or more processors may be further configured to initiate an execution of one or more user interactions with the one or more sets of private data based at least in part on the extracted set of data as inputted into the trusted network.

In particular embodiments, the extracted set of data may include one of a plurality of extracted sets of data extracted from a plurality of sets of public data. In particular embodiments, prior to detecting the interaction to initiate the execution of the one or more user interactions, the one or more processors may be further configured to train the one or more generative machine-learning models based at least in part on the plurality of extracted sets of data. In particular embodiments, the one or more processors may be further configured to execute the one or more generative machine-learning models further trained to extract the set of data to be inputted into the trusted network by mapping the set of public data to the trusted network to facilitate the identification of the one or more sets of private data included within the set of public data.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a combined classical computing and quantum computing system and network, in accordance with certain aspects of the present disclosure;

FIG. 2 illustrates a flowchart of an example method for securing and obfuscating data in software applications and networks utilizing quantum computing, in accordance with one or more embodiments of the present disclosure.

### DETAILED DESCRIPTION

### Example System

### System Overview

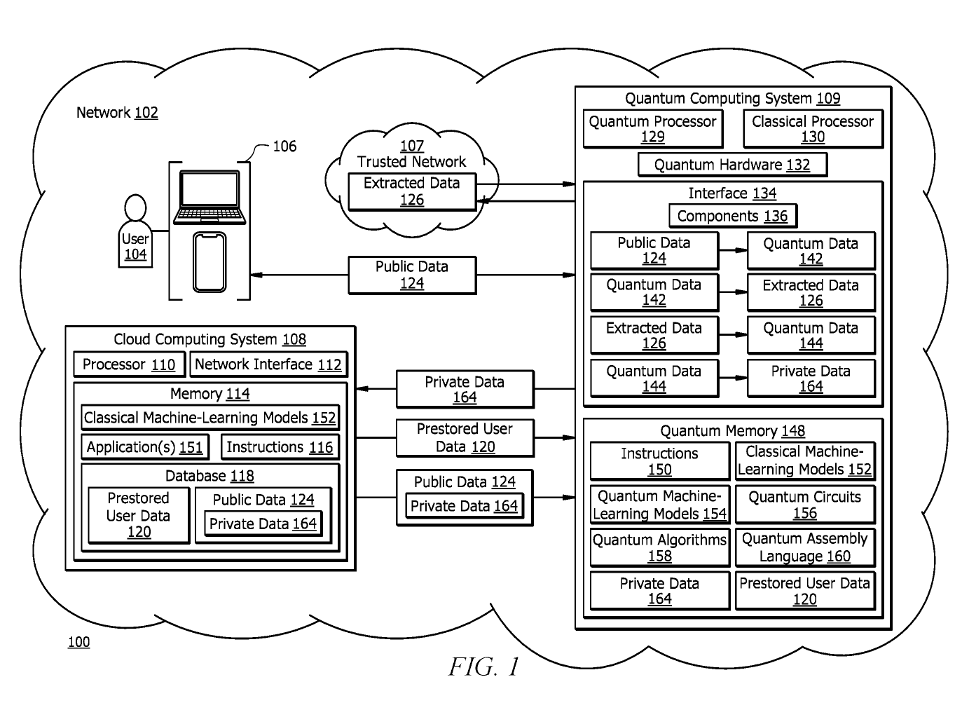

FIG. 1 is a block diagram of a combined classical computing and quantum computing system 100 and network. As depicted, the combined classical computing and quantum computing system 100 may include one or more computing devices 106 that may be associated with a user 104, a cloud computing system 108, a quantum computing system 109, and a network 102 that enables the communications between the one or more computing devices 106, the cloud computing system 108, and the quantum computing system 109. In particular embodiments, the cloud computing system 108 and the quantum computing system 109 may be owned and managed by a single entity or organization, and thus, in some embodiments, the cloud computing system 108 and the quantum computing system 109 may operate in conjunction and/or may be integrated to operate as a singular computing infrastructure.

In another embodiment, one of the cloud computing system 108 and the quantum computing system 109 may be owned and managed by the single entity or organization while the other one of the cloud computing system 108 and the quantum computing system 109 may be owned and managed by a third-party entity or organization and licensed to be utilized by the single entity or organization. In one embodiment, the cloud computing system 108 may include a classical computing system suitable for executing binary or bitwise processing operations. In contrast, the quantum computing system 109 may include a quantum computing system suitable for executing superposed and entangled or quantum bit (QuBit) based parallel processing operations.

### Network

Network 102 may be any suitable type of wireless and/or wired network. The network 102 may or may not be connected to the Internet or public network. The network 102 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private

network (VPN), a mobile telephone network (e.g., cellular networks, such as 4G or 5G), a plain old telephone (POT) network, a wireless data network (e.g., WiFi, WiGig, WiMAX, etc.), a long-term evolution (LTE) network, a universal mobile telecommunications system (UMTS) network, a peer-to-peer (P2P) network, a Bluetooth network, a near field communication (NFC) network, and/or any other suitable network. The network 102 may be configured to support any suitable type of communication protocol as would be appreciated by one of ordinary skill in the art.

### Computing Device

Computing device 106 is generally any device that may be utilized to process data and interact with a user 104. Examples of the computing device 106 include, but are not limited to, a personal computer, a desktop computer, a workstation, a server, a laptop, a tablet computer, a mobile phone (such as a smartphone), etc. The computing device 106 may include a user interface, such as a display, a microphone, keypad, or other appropriate terminal equipment usable by the user 104. The computing device 106 may include a hardware processor, memory, and/or circuitry (not explicitly shown) configured to perform any of the functions or actions of the computing device 106 described herein. For example, a software application designed using software code may be stored in the memory and executed by the processor to perform the functions of the computing device 106. The computing device 106 may be utilized to communicate with other components of the system 100 via the network 102.

In particular embodiments, the computing device 106 may be utilized by the user 104 to communicate and exchange public data 124 to the quantum computing system 109 and/or the cloud computing system 108. For example, in one embodiment, the computing device 106 may execute an instance of a software application 151 that may be hosted and executed by the cloud computing system 108. In particular embodiments, the user 104 may access the instance of the software application 151 executing on the computing device 106 and exchange public data 124 (e.g., one or more requests and/or replies) over the network 102 between the computing device 106 and the quantum computing system 109 and/or the cloud computing system 108. As will be discussed in greater detail below, the computing device 106 may be accessed or interacted with by, for example, a potential attacker, an eavesdropper, or other adversarial user. Without the presently disclosed embodiments, the potential attacker, eavesdropper, or other adversarial user would otherwise gain access and view of private data 164.

In particular embodiments, the quantum computing system 109 and/or the cloud computing system 108 may store prestored user data 120 associated with the user 104, such as identity data associated with the user 104, income data associated with the user 104, employment data associated with the user 104, residential address data associated with the user 104, date of birth (DOB) data associated with the user 104, business ownership data associated with the user 104, billing and invoice data associated with the user 104, a tax identification data associated with the user 104, facial features of the user 104, or other data associated with the user 104 that may be provided to the quantum computing system 109 and/or the cloud computing system 108.

### Cloud Computing System

The cloud computing system 108 may include any computing that may be utilized to process data and communicate with other components of the system 100 via the network 102. In one embodiment, the cloud computing system 108 may include a classical computing system suitable for executing binary or bitwise processing operations. As depicted, the cloud computing system 108 may include a processor 110 in signal communication with a memory 114 and a network interface 112.

Processor 110 may include one or more processors operably coupled to the memory 114. The processor 110 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The processor 110 may be a programmable logic device, a microcontroller, a microprocessor, or any suitable combination of the preceding. The one or more processors 110 may be utilized to process data and may be implemented in hardware or software.

For example, the processor 110 may be 8-bit, 16-bit, 32-bit, 64-bit, or of any other suitable architecture. The one or more processors 110 may be utilized to implement various software instructions to perform the operations described herein. For example, the one or more processors 110 may be utilized to execute software instructions 116 and perform one or more functions described herein. In one embodiment, the processor 110 may be understood to be a classical processor.

Network interface 112 may be utilized to enable wired and/or wireless communications (e.g., via network 102). The network interface 112 is configured to communicate data between the cloud computing system 108 and other components of the system 100. For example, the network interface 112 may include a WIFI interface, a local area network (LAN) interface, a wide area network (WAN) interface, a modem, a switch, or a router. The processor 110 may be utilized to send and receive data using the network interface 112. The network interface 112 may be utilized to use any suitable type of communication protocol as would be appreciated by one of ordinary skill in the art.

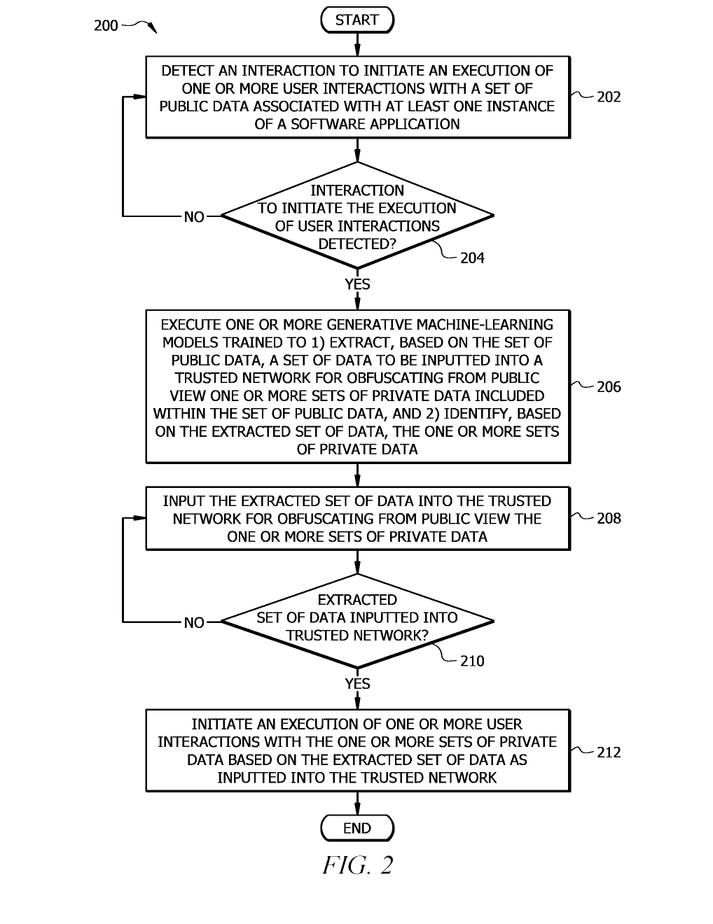

Memory 114 may be volatile or non-volatile and may include a read-only memory (ROM), random-access memory (RAM), ternary content-addressable memory (TCAM), dynamic random-access memory (DRAM), and static random-access memory (SRAM). Memory 114 may be implemented using one or more disks, tape drives, solid-state drives, and/or the like. The memory 114 may store any of the information described in FIGS. 1 and 2 along with any other data, instructions, logic, rules, or code operable to implement the function(s) described herein. The memory 114 is operable to store software instructions 116, and/or any other data and instructions.

The software instructions 116 may include any suitable set of software instructions, logic, rules, or code operable to be executed by the processor 110. In particular embodiments, the memory 114 may further store a database 118, which may include a structured data base (e.g., structured query language (SQL) database, a non-SQL database, or other similar relational database), an unstructured database, a sorted data structure, or an unsorted data structure. In one embodiment, the memory 114 may be understood to be a classical memory. In one embodiment, the memory 114 may include a non-transitory computer-readable medium.

In particular embodiments, the database 118 may store the prestored user data 120 and public data 124. In particular embodiments, the prestored user data 120 may include, for example, identity data associated with the user 104, income data associated with the user 104, employment data associated with the user 104, residential address data associated with the user 104, date of birth (DOB) data associated with the user 104, business ownership data associated with the user 104, billing and invoice data associated with the user 104, a tax identification number associated with the user 104, facial features of the user 104, other user data that may be extracted and stored by the quantum computing system 109 and/or the cloud computing system 108 as prestored user data 120.

In particular embodiments, the public data 124 may include any data that may be viewable by public users and may be exchanged between the computing device 106 and the quantum computing system 109 and/or the cloud computing system 108 over a public network 102. For example, in one embodiment, the public data 124 may include a public webpage, a public electronic document, a public videoconference, a public software application, or other public data 124 that may be exchanged between the computing device 106 and the quantum computing system 109 and/or the cloud computing system 108.

In contrast, the private data 164 may include any confidential data, proprietary data, sensitive data, or other data may be unviewable by public users and restricted to the access and view by preauthorized and/or preauthenticated users and may be generally exchanged between the computing device 106 and the quantum computing system 109 and/or the cloud computing system 108 over a trusted network 107 in accordance with the presently disclosed embodiments. For example, in one embodiment, the private data 164 may include sensitive data associated with the user 104, proprietary business data, proprietary technical data, or other private data 164 that may be restricted to the access and view by only preauthorized and/or preauthenticated users.

### Quantum Computing System

The quantum computing system 109 may include any quantum computing system that may be utilized to process data and communicate with other components of the system 100 via the network 102. In one embodiment, the quantum computing system 109 may include a quantum computing system suitable for executing superposed and entangled or quantum bit (QuBit) based parallel processing operations. As depicted, the quantum computing system 109 may include a quantum processor 129, a classical processor 130, and an interface 134 in signal communication with a quantum memory 148.

The quantum processor 129 may include one or more quantum processors operably coupled to the quantum memory 148. The quantum processor 129 is configured to process quantum bits (QuBits). The quantum processor 129 may include a superconducting quantum device (with qubits implemented by states of Josephson junctions), a trapped ion device (with qubits implemented by internal states of trapped ions), a trapped neutral atom device (with qubits implemented by internal states of trapped neutral atoms), a photon-based device (with qubits implemented by modes of photons), or any other suitable device that implements quantum bits with states of a respective quantum system.

In particular embodiments, the quantum processor 129 may be a quantum processing unit (QPU), which may include a number of quantum registers, a dedicated quantum memory, and a number of quantum logic gates (e.g., a quantum logic gate, a Hadamard logic gate, a Pauli-X logic gate, a Pauli-Y logic gate, a Pauli-Z logic gate, a controlled NOT logic gate, and so forth) suitable for executing superposed and entangled or quantum bit (QuBit) based parallel processing operations.

In particular embodiments, the quantum processor 129 may be further utilized to perform quantum computations, such as quantum annealing, quantum simulations, and universal quantum computing. For example, in particular embodiments, the quantum processor 129 may, in conjunction with the quantum memory 148 and utilizing the quantum hardware 132, execute one or more classical machine-learning (CML) models 152, one or more quantum machine-learning (QML) models 154, one or more quantum circuits 156, one or more quantum algorithms 158, and/or one or more quantum assembly languages 160 for performing operations on the extracted user data 164 and the prestored user data 120.

In particular embodiments, the one or more classical machine-learning (CML) models 152 may include, for example, one or more of a spiking neural network (SNN), an autoencoder (AE), a variational autoencoder (VAE), a generative adversarial network (GAN), a convolutional neural network (CNN), a deep neural network (DNN), a deep convolutional neural network (DCNN), a graph neural network (GNN), a graph convolutional network (GCN), a bidirectional and auto-regressive transformer (BART) model, a bidirectional encoder representations for transformer (BERT) model, a generative pre-trained transformer (GPT) model, a graph transformer, or other similar machine-learning model. In another embodiment, the one or more classical machine-learning (CML) models 152 may include one or more language models (LMs) or large language model (LLMs).

Similarly, in particular embodiments, the one or more quantum machine-learning (QML) models 154 may include one or more of a quantum-enhanced machine-learning model, a quantum-inspired machine-learning model, a quantum-generalized machine-learning model, or any of various other machine-learning models in which the processing power of quantum computing and the properties of quantum physics are utilized to accelerate machine-learning tasks. Specifically, it should be appreciated that the quantum computing system 109 may be capable of executing both the one or more classical machine-learning (CML) models 152 and the one or more quantum machine-learning (QML) models 154 in accordance with the presently disclosed embodiments. On the other hand, the cloud computing system 108 may be capable of executing only the one or more classical machine-learning (CML) models 152.

In particular embodiments, the quantum hardware 132 may include, for example, a number of quantum bits (QuBits), a number of QuBit connectors, a number of QuBit interconnector circuits for control operations, and a quantum random access memory (QRAM). The one or more quantum circuits 156 may include a sequence of quantum logic gates suitable for representing and expressing each step of the one or more one or more quantum algorithms 158. For example, the one or more quantum algorithms 158 may include any of various quantum algorithms, such as quantum annealing algorithms, quantum simulation algorithms, quantum search algorithms (e.g., Grover’s algorithm), quantum cryptography algorithms (e.g., Shor’s algorithm), one or more quantum Fourier transform (QFT) based algorithms or inverse quantum Fourier transform (iQFT) based algorithms, one or more classical quantum hybrid algorithms (e.g., Quantum Eigensolver), one or more classical quantum variational algorithms, and/or other user-developed quantum algorithms that may be represented by instructions 150.

The classical processor 130 may include one or more processors operably coupled to the quantum memory 148. The classical processor 130 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The classical processor 130 may be a programmable logic device, a microcontroller, a microprocessor, or any suitable combination of the preceding. The one or more processors are configured to process data and may be implemented in hardware or software. For example, the classical processor 130 may be 8-bit, 16-bit, 32-bit, 64-bit, or of any other suitable architecture. The one or more processors are configured to implement various software instructions to perform the operations described herein.

The interface 134 may be utilized to convert data items represented by classical binary bits of data into to quantum bits (QuBits) of data. For example, in particular embodiments, the interface 134 may convert public data 124 represented as classical binary bits of data into quantum data 142 for inputting into one or more QML models 154, and, similarly, convert extracted data 126 represented as classical binary bits of data into quantum data 144 for inputting into one or more QML models 154, for example.

In particular embodiments, the quantum computing system 109 may utilize the one or more classical machine-learning (CML) models 152, the one or more quantum machine-learning (QML) models 154, or some combination thereof to extract from the public data 124 the extracted data 126 to be inputted into a trusted network 107 for obfuscating from public view any private data 164 that may be included within the public data 164. The quantum computing system 109 may further utilize the one or more classical machine-learning (CML) models 152, the one or more quantum machine-learning (QML) models 154, or some combination thereof to identify, based on the extracted data 126, the private data 164 as inputted to the trusted network 107.

In particular embodiments, the trusted network 107 may include a private network (e.g., virtual private network (VPN) or other similar private network) that may be instantiated and utilized to receive the extracted data 126 for further analysis, integration, processing, and/or migration all while concealed from public view via the public network 102. Specifically, in accordance with the presently disclosed embodiments, the extracted data 126 may include both public data (e.g., public data 124) and private data 164 as inputted into the trusted network 107, such that as the private data 164 is analyzed, migrated, or processed, potential attackers, eavesdroppers, or other adversarial users may be impeded from deciphering the private data 164 from amongst the voluminous public data 124.

That is, by the extracted data 126 including both public data (e.g., public data 124) and private data 164 as inputted into the trusted network 107, the public data 124 may serve as decoy data to deceive and isolate potential attackers, eavesdroppers, or other adversarial users. In another embodiment, the trusted network 107 may include a “pop-up” private network that may be instantiated extemporaneously in response to the quantum computing system 109 identifying and extracting from the public data 124 the extracted data 126 to be inputted into a trusted network 107 for obfuscating from public view any private data 164 that may be included within the public data 164. For example, upon the one or more classical machine-learning (CML) models 152 and/or the one or more quantum machine-learning (QML) models 154 identifying private data 164 amongst the public data 124, the quantum computing system 109 may cause to be instantiated the trusted network 107 for obfuscating from public view any private data 164 that may be included within the public data 164.

In particular embodiments, the interface 134 may be further utilized to convert data items represented by quantum bits (QuBits) of data into classical binary bits of data. For example, in particular embodiments, upon the quantum computing system 109 extracting data from the public data 124 based on the quantum data 142, the interface 134 may convert the quantum data 142 representing the extracted data 126 into classical binary bits of data representing the extracted data 126. Likewise, upon the quantum computing system 109 identifying private data 164 based on the quantum data 144, the interface 134 may convert the quantum data 144 representing the private data 164 into classical binary bits of data representing the private data 164.

In particular embodiments, the interface 134 may include a number of components 136 that may be utilized to generate and manipulate quantum bits (QuBits. In the illustrated embodiment, the number of components 136 and the quantum processor 129 are configured to operate on a same type of quantum bits (QuBits). For example, when the quantum processor 129 includes a photon-based device (with qubits implemented by modes of photons), the number of components 136 may include optical components such as lasers, mirrors, prisms, waveguides, interferometers, optical fibers, filters, polarizers, and/or lenses.

Quantum memory 148 may include a quantum read-only memory (QROM), quantum random-access memory (QRAM), or other similar quantum memory. The quantum memory 148 may store any of the information described in FIGS. 1 and 2 along with any other data, instructions, logic, rules, or code operable to implement the function(s) described herein. The quantum memory 148 is operable to store software instructions 150, and/or any other data and instructions. The software instructions 150 may include any suitable set of software instructions, logic, rules, or code operable to be executed by the quantum processor 129. In one embodiment, the quantum memory 148 may include a non-transitory computer-readable medium.

### Securing and obfuscating data in software applications and networks utilizing quantum computing

FIG. 2 illustrates a flowchart of an example method 200 for securing and obfuscating data in software applications and networks utilizing quantum computing, in accordance with one or more embodiments of the present disclosure. The method 200 may be performed by the combined classical computing and quantum computing system 100 as described above with respect to FIG. 1. For example, in one embodiment, the method 200 may be performed by the cloud computing system 108 alone. In another embodiment, the method 200 may be performed by the quantum computing system 109 alone. In yet another embodiment, the method 200 may be performed in conjunction by the cloud computing system 108 and the quantum computing system 109.

The method 200 may begin at block 202 with the cloud computing system 108 and/or the quantum computing system 109 detecting an interaction to initiate an execution of one or more user interactions with a set of public data associated with at least one instance of a software application. For example, in one embodiment, the user 104 may launch an instance of the software application 155 on the computing device 106 and may interact with public data 124 associated with the instance of the software application 155 utilizing the computing device 106.

In particular embodiments, the method 200 may continue at decision 204 with the cloud computing system 108 and/or the quantum computing system 109 confirming whether the interaction to initiate the execution of one or more user interactions has been detected. In particular embodiments, in response to determining that the interaction to initiate the execution of one or more user interactions has not been detected (e.g., at decision 204), the method 200 may return to block 202. On the other hand, in response to determining that the interaction to initiate the execution of one or more user interactions has been detected (e.g., at decision 204), the method 200 may continue at block 206 with the cloud computing system 108 and/or the quantum computing system 109 executing one or more generative machine-learning models trained to 1) extract, based on the set of public data, a set of data to be inputted into a trusted network for obfuscating from public view one or more sets of private data included within the set of public data, and 2) identify, based on the extracted set of data, the one or more sets of private data.

For example, in particular embodiments, the cloud computing system 108 and/or the quantum computing system 109 may execute one or more classical machine-learning (CML) models 152 or one or more quantum machine-learning (QML) models 154 to extract from the set of public data 124 a set of data to be inputted into a trusted network 107 for obfuscating from public view the one or more sets of private data 164 included within the set of public data 124 and identify the one or more sets of private data 164 based on the set of extracted data 126.

In particular embodiments, the method 200 may continue at block 208 with the cloud computing system 108 and/or the quantum computing system 109 inputting the extracted set of data into the trusted network for obfuscating from public view the one or more sets of private data. For example, in particular embodiments, the cloud computing system 108 and/or the quantum computing system 109 may input or inject the set of extracted data 126 as extracted from the larger set of public data 124 into the trusted network 107 for obfuscating from public view the one or more sets of private data 164.

In particular embodiments, the method 200 may continue at decision 210 with the cloud computing system 108 and/or the quantum computing system 109 confirming whether the extracted set of data has been inputted into the trusted network. In particular embodiments, in response to determining that the set of extracted data 126 has not been inputted into the trusted network 107 (e.g., at decision 210), the method 200 may return to block 208. On the other hand, in response to determining that the set of extracted data 126 has been inputted into the trusted network 107 (e.g., at decision 210), the method 200 may then conclude at block 212 with the cloud computing system 108 and/or the quantum computing system 109 initiating an execution of one or more user interactions with the one or more sets of private data 164 based on the set of extracted data 126 as inputted into the trusted network 107.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory configured to store instances of a software application executable on a computing device and a set of public data associated with at least one instance of the software application; and
one or more processors operably coupled to the memory and configured to:
detect an interaction to initiate an execution of one or more user interactions with the set of public data associated with the at least one instance of the software application, and, in response:
execute one or more generative machine-learning models trained to 1) extract, based at least in part on the set of public data, a set of data to be inputted into a trusted network for obfuscating from public view one or more sets of private data included within the set of public data, and 2) identify, based at least in part on the extracted set of data, the one or more sets of private data as inputted into the trusted network;
input the extracted set of data into the trusted network for obfuscating from public view the one or more sets of private data; and
in response to the extracted set of data being inputted into the trusted network, initiate an execution of one or more user interactions with the one or more sets of private data based at least in part on the extracted set of data as inputted into the trusted network.

2. The system of claim 1, wherein the one or more generative machine-learning models comprises one or more classical machine-learning (CML) models, one or more quantum machine-learning (QML) models, or a combination thereof.

3. The system of claim 1, wherein the extracted set of data comprises the one or more sets of private data and a subset of public data included within the set of public data.

4. The system of claim 1, wherein the one or more processors are further configured to detect the interaction to initiate the execution of the one or more user interactions with the set of public data based on the computing device.

5. The system of claim 1, wherein the one or more processors are further configured to store the extracted set of data as one or more quantum bits (QuBits) of data to a quantum memory of the system or as one or more bits of data to a relational database of the system.

6. The system of claim 1, wherein the extracted set of data comprises one of a plurality of extracted sets of data extracted from a plurality of sets of public data, and wherein the one or more processors are further configured to:
prior to detecting the interaction to initiate the execution of the one or more user interactions, train the one or more generative machine-learning models based at least in part on the plurality of extracted sets of data.

7. The system of claim 1, wherein the one or more processors are further configured to execute the one or more generative machine-learning models further trained to extract the set of data to be inputted into the trusted network by mapping the set of public data to the trusted network, the set of public data being mapped to the trusted network for facilitating the identification of the one or more sets of private data as inputted into the trusted network.

8. A method, comprising:
detecting an interaction to initiate an execution of one or more user interactions with a set of public data associated with at least one instance of a software application of a plurality of instances of the software application, and, in response:
executing one or more generative machine-learning models trained to 1) extract, based at least in part on the set of public data, a set of data to be inputted into a trusted network for obfuscating from public view one or more sets of private data included within the set of public data, and 2) identify, based at least in part on the extracted set of data, the one or more sets of private data as inputted into the trusted network;
inputting the extracted set of data into the trusted network for obfuscating from public view the one or more sets of private data; and
in response to the extracted set of data being inputted into the trusted network, initiating an execution of one or more user interactions with the one or more sets of private data based at least in part on the extracted set of data as inputted into the trusted network.

9. The method of claim 8, wherein the one or more generative machine-learning models comprises one or more classical machine-learning (CML) models, one or more quantum machine-learning (QML) models, or a combination thereof.

10. The method of claim 8, wherein the extracted set of data comprises the one or more sets of private data and a subset of public data included within the set of public data.

11. The method of claim 8, wherein detecting the interaction to initiate the execution of the one or more user interactions with the set of public data comprises detecting the interaction based on a computing device.

12. The method of claim 8, further comprising:
storing the extracted set of data as one or more quantum bits (QuBits) of data to a quantum memory or as one or more bits of data to a relational database.

13. The method of claim 8, wherein the extracted set of data comprises one of a plurality of extracted sets of data extracted from a plurality of sets of public data, the method further comprising:
prior to detecting the interaction to initiate the execution of the one or more user interactions, training the one or more generative machine-learning models based at least in part on the plurality of extracted sets of data.

14. The method of claim 8, further comprising executing the one or more generative machine-learning models further trained to extract the set of data to be inputted into the trusted network by mapping the set of public data to the trusted network, the set of public data being mapped to the trusted network for facilitating the identification of the one or more sets of private data as inputted into the trusted network.

15. A non-transitory computer-readable medium storing instructions that, when executed by one or more processors, cause the one or more processors to:
detect an interaction to initiate an execution of one or more user interactions with a set of public data associated with at least one instance of a software application of a plurality of instances of the software application, and, in response:
execute one or more generative machine-learning models trained to 1) extract, based at least in part on the set of public data, a set of data to be inputted into a trusted network for obfuscating from public view one or more sets of private data included within the set of public data, and 2) identify, based at least in part on the extracted set of data, the one or more sets of private data as inputted into the trusted network;
input the extracted set of data into the trusted network for obfuscating from public view the one or more sets of private data; and
in response to the extracted set of data being inputted into the trusted network, initiate an execution of one or more user interactions with the one or more sets of private data based at least in part on the extracted set of data as inputted into the trusted network.

16. The non-transitory computer-readable medium of claim 15, wherein the one or more generative machine-learning models comprises one or more classical machine-learning (CML) models, one or more quantum machine-learning (QML) models, or a combination thereof.

17. The non-transitory computer-readable medium of claim 15, wherein the extracted set of data comprises the one or more sets of private data and a subset of public data included within the set of public data.

18. The non-transitory computer-readable medium of claim 15, wherein the instructions further cause the one or more processors to store the extracted set of data as one or more quantum bits (QuBits) of data to a quantum memory or as one or more bits of data to a relational database.

19. The non-transitory computer-readable medium of claim 15, wherein the instructions further cause the one or more processors to detect the interaction to initiate the execution of the one or more user interactions with the set of public data based on a computing device.

20. The non-transitory computer-readable medium of claim 15, wherein the extracted set of data comprises one of a plurality of extracted sets of data extracted from a plurality of sets of public data, and wherein the instructions further cause the one or more processors to:
prior to detecting the interaction to initiate the execution of the one or more user interactions, train the one or more generative machine-learning models based at least in part on the plurality of extracted sets of data.
